(19) United States
(12) Patent Application Publication
(10) Pub. No.: US 2013/0346661 A1
(43) Pub. Date: Dec. 26, 2013

(54) METHODS AND SYSTEMS FOR MOBILE DEVICE DOCKING

(71) Applicant: HENDRICKS INVESTMENT HOLDINGS, LLC, SILVER SPRING, MD (US)

(72) Inventor: Stephen Ignatius HASENEI, Silver Spring, MO (US)

(21) Appl. No.: 13/925,468

(22) Filed: Jun. 24, 2013

Related U.S. Application Data
(60) Provisional application No. 61/663,949, filed on Jun. 25, 2012.

(51) Int. Cl. G06F 1/16

(52) U.S. Cl. CPC G06F 1/1632
USPC 710/303

(57) ABSTRACT

Methods and apparatuses for attaching a portable electronic device to a docking system, the method including establishing a connection between a portable device and a docking system using a magnetic force generated between a flexible magnetic interface attached to the docking system and magnetic material attached to the portable device. The methods and apparatuses also include transferring power to the portable device using the connection. In addition, the methods and apparatuses include transferring data between the portable device and the docking system using the connection.

### RELATED APPLICATIONS

This application claims the benefit of priority to U.S. Provisional Application No. 61/663,949 entitled “Methods and Systems for Mobile Device Docking,” filed Jun. 25, 2012. The preceding application is incorporated by reference in its entirety herein.

### BACKGROUND

With the proliferation of mobile devices that have increased power, memory, and other new features, more and more wireless devices are being used for entertainment purposes, including for executing content such as games, movies, and audio. By using mobile devices for entertainment purposes, the power supply of the mobile device may be used up quickly. Typically when a power supply, such as a battery, of a mobile device depletes, a user of the mobile device attaches the mobile device to a power supply, such as a power cord, to replenish the power supply. Power cords are frequently misplaced by users and/or left behind when users travel. In addition, power cords and jacks can become damaged and thus unusable for charging purposes. Thus, there is a need in the art for an easy and effortless connection to replenish a power supply in a mobile device without having to attach a cord and/or jack to the mobile device.

### SUMMARY

Aspects of the present invention relate to methods and systems for providing power to devices using a docking system. Aspects of the present invention also relate to methods and systems for providing a central hub for data communications between devices in communication with a docking system. In addition, aspects of the present invention relate to methods and systems for docking and/or attaching mobile devices to a docking system.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example docking system in accordance with an aspect of the present invention;

FIGS. 2A-2E illustrate example mobile devices in relation to a docking system in accordance with aspects of the present invention;

FIG. 3 illustrates an overall description of a docking system in accordance with an aspect of the present invention;

FIGS. 4A-4B illustrate a rear view and a front view of an example docking system in accordance with an aspect of the present invention;

FIGS. 5A-5D illustrate example devices in communication with a docking system in accordance with an aspect of the present invention;

FIG. 6 illustrates an overall description of a docking system in accordance with an aspect of the present invention;

FIGS. 7A-7B illustrate a rear view and a front view of an example docking system in accordance with an aspect of the present invention;

FIGS. 8A-8B illustrate example devices in communication with a docking system in accordance with an aspect of the present invention;

FIG. 9 illustrates an example method flow for docking a portable device in accordance with an aspect of the present invention;

FIG. 10 illustrates an example method flow for providing a central hub for data communications among devices in communication with a docking system in accordance with an aspect of the present invention;

FIG. 11 illustrates an example system in accordance with an aspect of the present invention;

FIG. 12 illustrates various features of an example computer system for use in conjunction with aspects of the present invention; and

FIG. 13 illustrates an example system diagram of various hardware components and other features, in accordance with aspects of the present invention.

### DETAILED DESCRIPTION

Aspects of the present invention relate to methods and systems for providing power to mobile or other portable devices using a docking system. For example, the docking system may provide such devices with, for example, a power source via a flexible magnetic interface and/or a universal serial bus (USB) port for providing power to devices. Aspects of the present invention also relate to methods and systems for providing a central hub for data communications among devices in communication with a docking system. For example, the docking system may provide an analog or digital jack for providing audio to a sound system, an Ethernet port for connecting to an access network, a wireless access point (WAP), and/or a high-definition multimedia (HDMI) tuner for providing video to various devices in communication with the docking system.

In addition, aspects of the present invention relate to methods and systems for docking (interchangeably referred to herein as joining or attaching) mobile devices to the docking system. The docking system may use a flexible magnetic interface to allow effortless connecting of the mobile/portable devices to the docking system without the use of connectors, such as USB connectors and/or power cords.

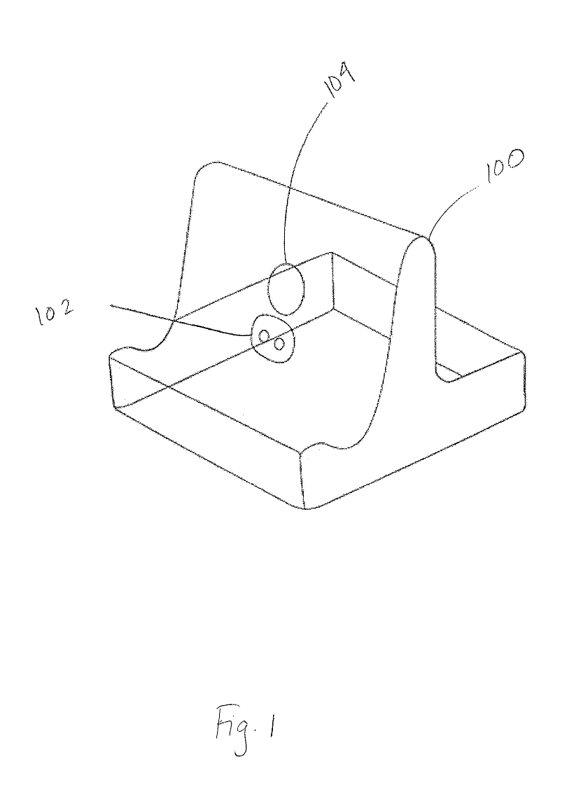

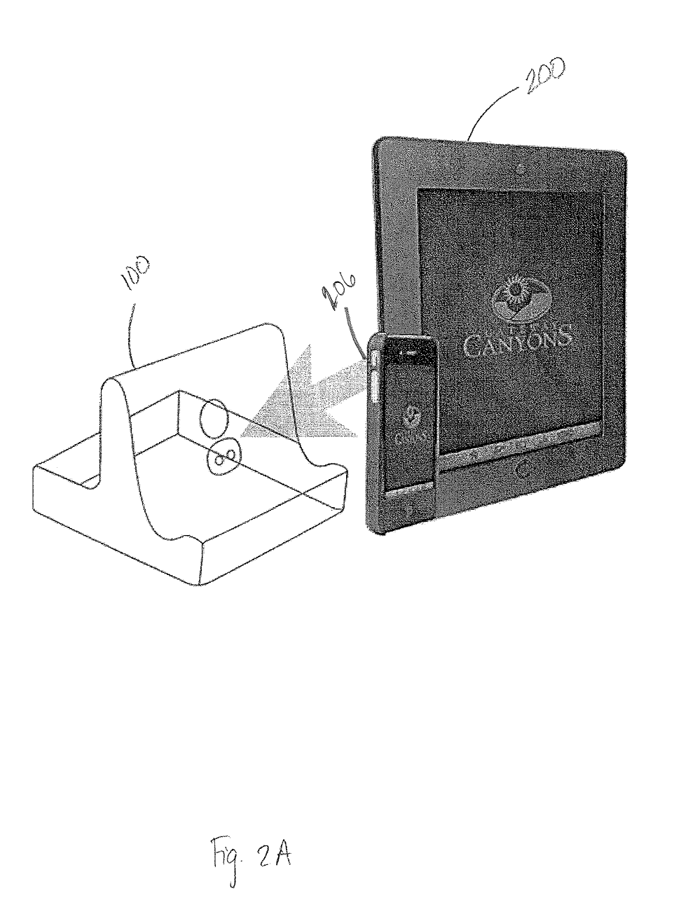

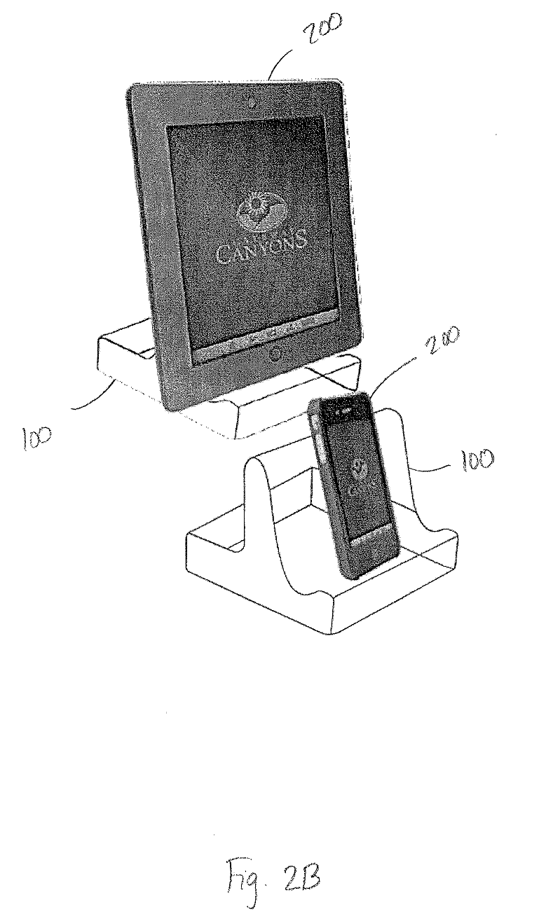

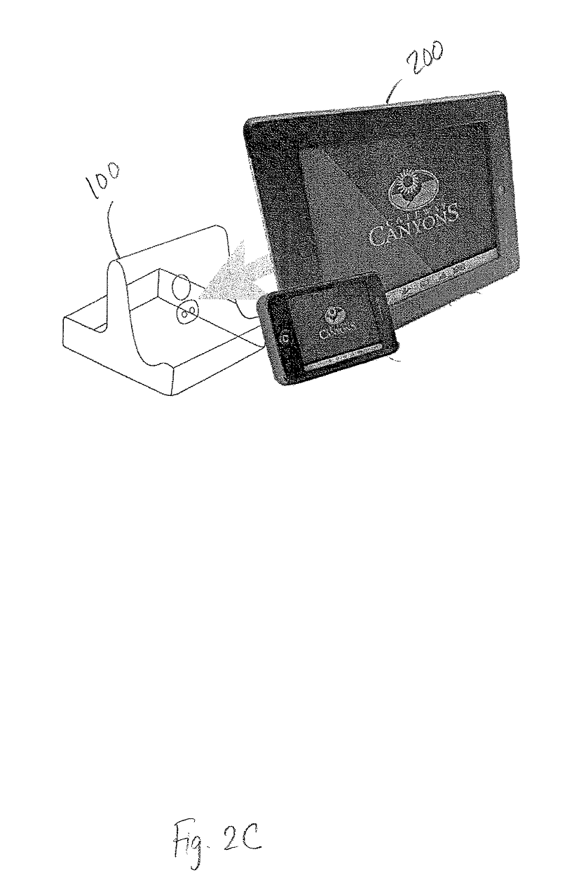

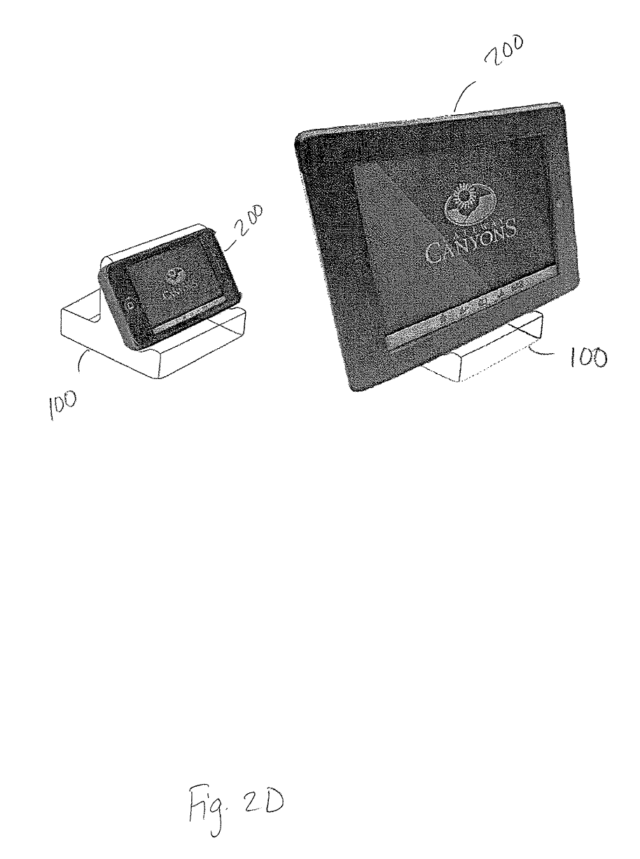

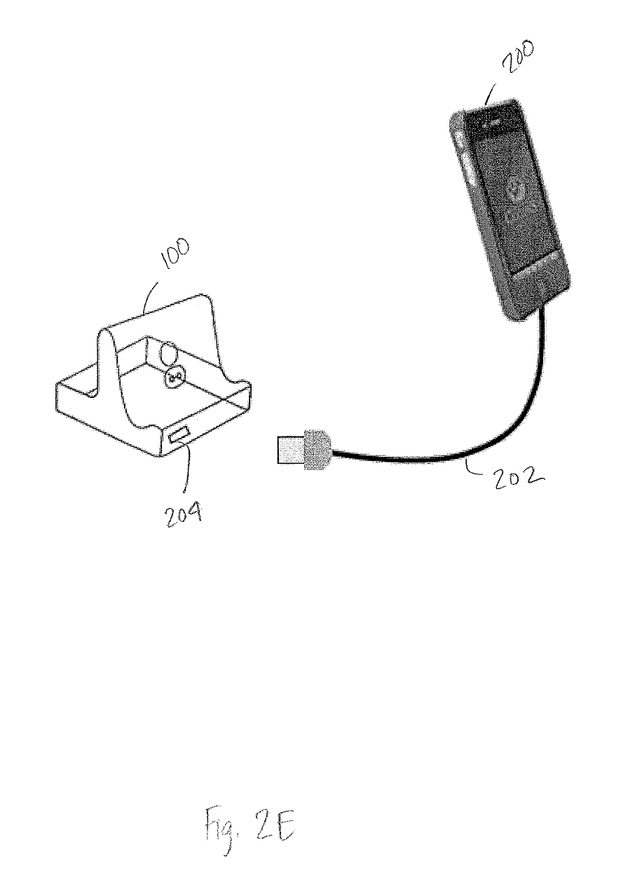

Referring now to FIG. 1, therein illustrated is an example docking system 100 in accordance with an aspect of the present invention. Docking system 100 may include a flexible magnetic interface (FMI) 102. In an aspect, the FMI 102 may contain a flexible contact with a plurality of contact points. The flexible contact may conform to the shape of the plurality of magnets floating behind each contact point on the FMI 102. See U.S. Pat. No. 8,187,006 titled “Flexible Magnetic Interconnects,” which is incorporated herein by reference in its entirety, for a more detailed description of the FMI. In addition, the plurality of magnets in the FMI 102 may generate a magnetic force that is capable of providing both an electrical connection and a mechanical connection with a mobile device 200 (FIG. 2) that is docked in the docking system 100. In an aspect, mobile device 200 may also contain a set of magnets and/or magnetic material 206 (FIG. 2) that may be used to connect mobile device 200 with the docking system 100. When the magnets and/or magnetic material 206 attached to mobile device 200 is within a range of the FMI 102, the magnets and/or magnetic material 206 attached to mobile device 200 may be attracted to the magnets in the FMI 102.

The magnetic force generated between the magnets 206 in mobile device 200 and the magnets in the FMI 102 may hold and/or connect mobile device 200 to the docking system 100 and provide a mechanical connection between device 200 and docking system 100. As such, the mechanical connection may provide a connection between two solid elements (e.g., a solid docking station and a solid device). In addition, the magnetic force generated may also provide an electrical connection, such as providing power and/or recharging a power source on mobile device 200. Further, a data connection among devices in communication with docking system may be established. Further, when the connection is an electrical connection, a data connection among devices in communication with the docking system may be established. Thus, FMI 102 may provide an interface for docking mobile device 200 to the docking system 100 without the use of connectors, such as USB connectors and/or power cords.

The docking system 100 may accommodate both landscape and portrait docking of a mobile device, as illustrated in FIGS. 2A-2D. Referring now to FIGS. 2A and 2B, therein illustrated is an example of a mobile device 200 in a portrait position in relation with the docking system 100. FIGS. 2C and 2D show an example of a mobile device 200 in a landscape position in relation with the docking system 100. Mobile devices 200 may include any mobile, portable computing or communications device, such as, but not limited to, a cellular device, a navigation system, a computing device, a tablet device, a camera, a PDA, a music device, a gaming device or a handheld device having wireless connection capability, among other devices.

Referring now to FIG. 2E, therein illustrated is an example of a mobile device 200 using a USB connector 202 to connect to docking system 100 via a USB port 204. Mobile device 200 may connect to docking system 100 using a USB connector 202, for example, when mobile device 200 does not have a magnetic interface to connect to FMI 102 (FIG. 1). Therefore, mobile device 200 may receive power and/or recharge a power supply on mobile device 200 from docking system via the USB connector 202. In addition, mobile device 200 may use USB connector 202 for downloading data from one or more other devices in communication with docking system 100.

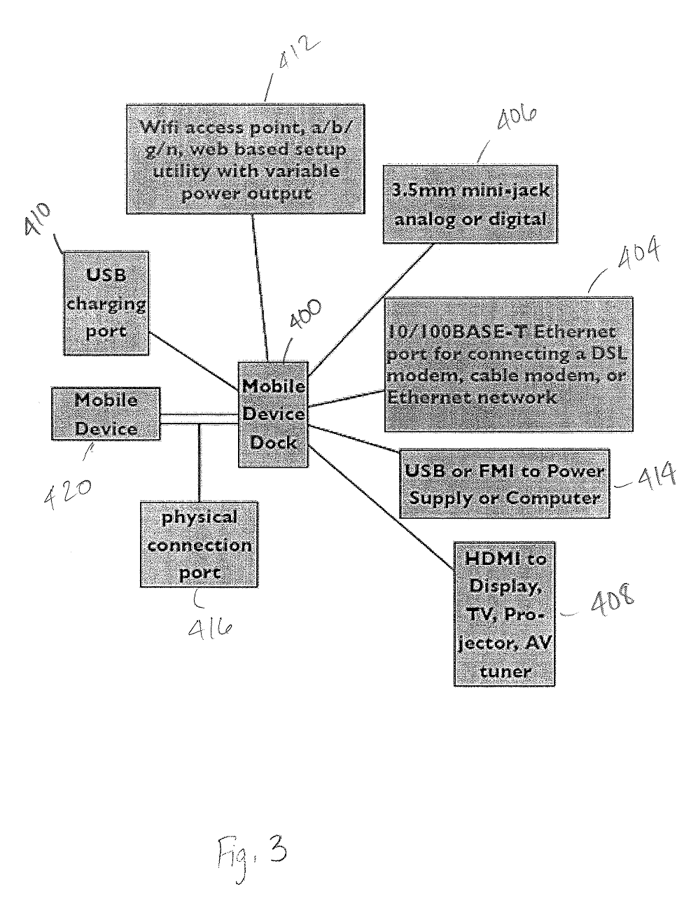

Referring now to FIG. 3, therein illustrated is an example overall description of a docking system 400 in accordance with an aspect of the present invention. For example, the docking device 400 may include a USB charging port 410, a Wi-Fi access point 412, a mini-jack port 406 for analog or digital signals, an Ethernet port 404, a USB or FMI power supply 414, a HDMI tuner 408, and/or a physical connection port 416 to a mobile device 420.

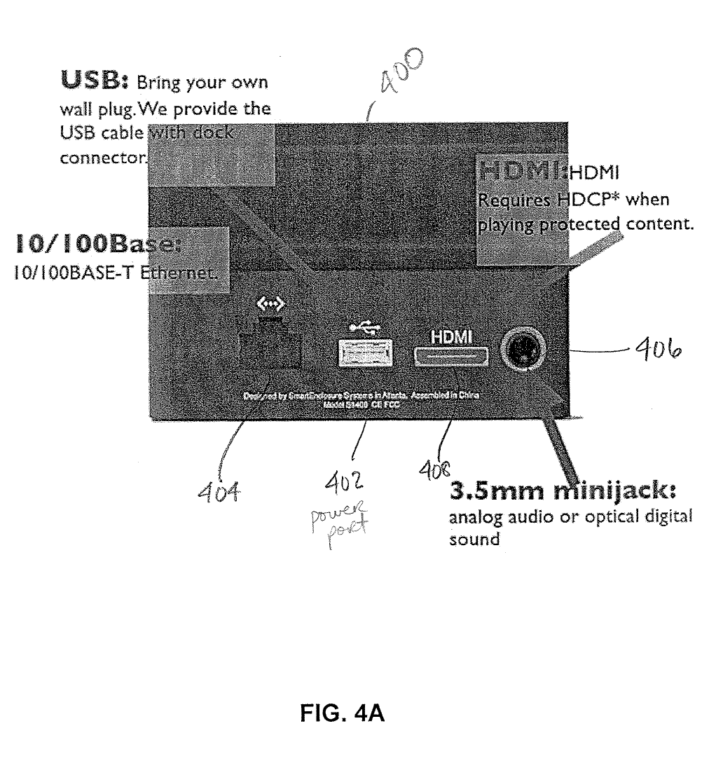

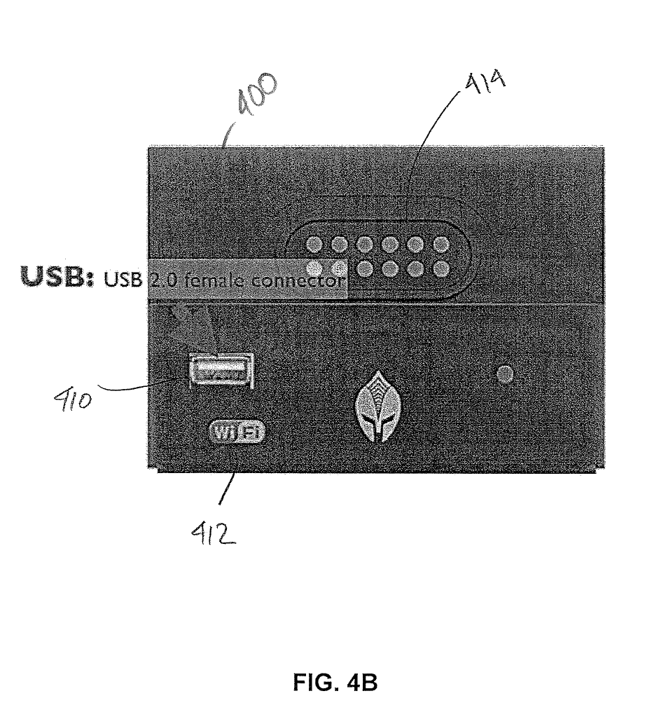

Referring now to FIG. 4A, therein illustrated is a rear view of the docking system 400 shown in FIG. 3. For example, the docking system may have a power port 402 configured to receive power from a wall outlet via a power cord. The docking system may also include a HDMI port 408 that may be used to connect to a display, a television, a projector and/or an AV receiver. The HDMI port 408 may send a video signal to be presented on a device in communication with the HDMI port 408. For example, the docking system 400 may convert analog signals from a device in communication with the HDMI port 408 to HDMI 720p HD resolution. In an aspect, the HDMI port 408 may integrate high-bandwidth digital content protection (HDCP) to prevent the interception of digital data midstream between the source and display, and thus, allow the display of protected content via the HDMI port 408.

In addition, the docking system may include an audio mini-jack port 406, such as a 3.5 mm mini-jack, to for analog or optical digital sound (e.g., Toslink). The docking system may also include an Ethernet port 404 for connecting to a DSL modem, a cable modem, or Ethernet network.

Referring now to FIG. 4B, therein illustrated is a front view of the docking system 400 shown in FIG. 3. The docking system may include a USB port 410. The USB port 410 may allow charging of non-dockable mobile devices and/or data transfers to mobile devices. In addition, the docking system may include a Wifi access point 412. Wifi access point 412 may provide data connectivity to any computing device and/or mobile device capable of Wifi connectivity. It should be noted that the Wifi access point 412 may support a plurality of devices. In an aspect, the Wifi access point 412 may provide data connectivity to up to four devices in communication with the docking system.

In addition, the Wifi access point 412 may allow any computer with a web browser and Wifi capability to manage the docking system remotely. In an aspect, a computer may send content, such as a movie, television show, and/or a song to be displayed on a device in communication with the docking system. For example, the computer may send a movie to docking system via the Wifi access point 412 to be displayed by a projector in communication with the HDMI port 408 and have a sound system in communication with the mini-jack port 406 play the associated sound.

In another aspect, a mobile device may be capable of streaming a television show. When the mobile device is docked in the docking system, the docking system may allow a television that is in communication with the docking system to present the movie currently streaming on the mobile device. Thus, it should be noted that the docking system may act as a central hub for data communication between a variety of devices in communication with the docking system.

In addition, the docking system may include a FMI 414 to connect and/or dock a mobile device to the docking system. As discussed above, the FMI 414 may provide both a mechanical connection to the wireless device (e.g., join the wireless device to the docking system) and an electrical connection (e.g., provide a power supply and/or data connection to the mobile device).

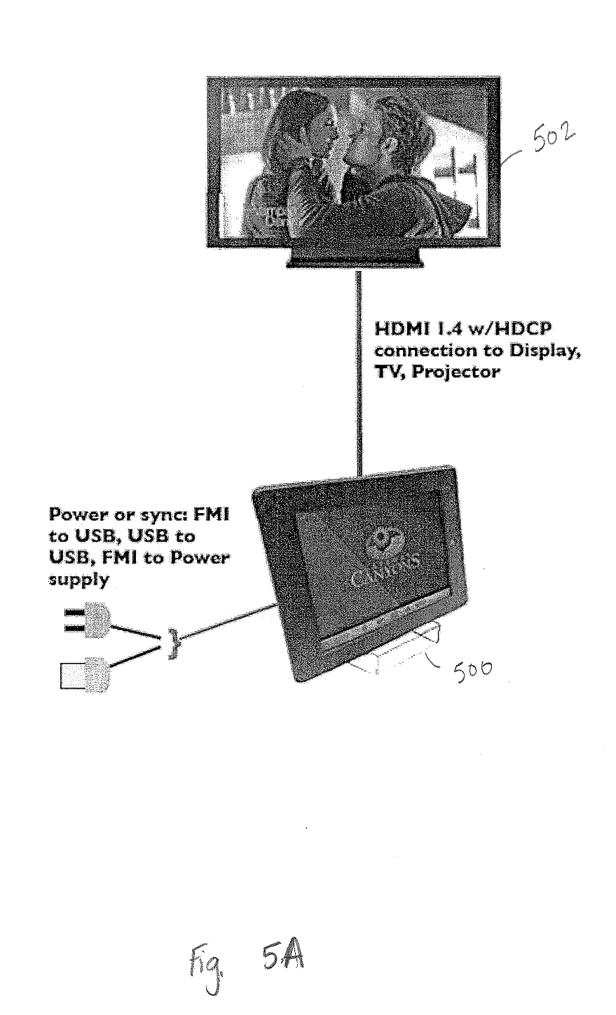

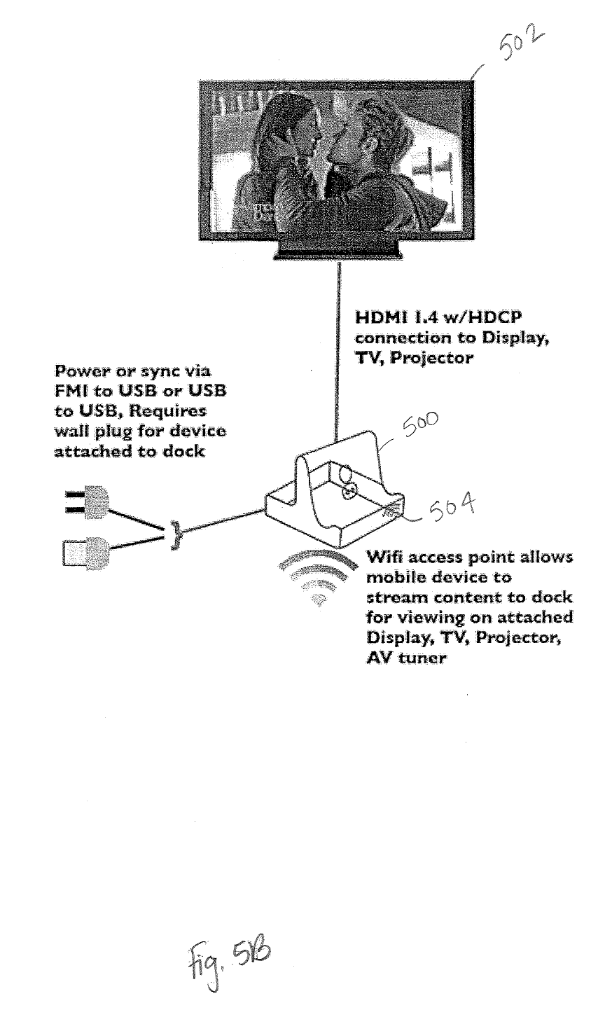

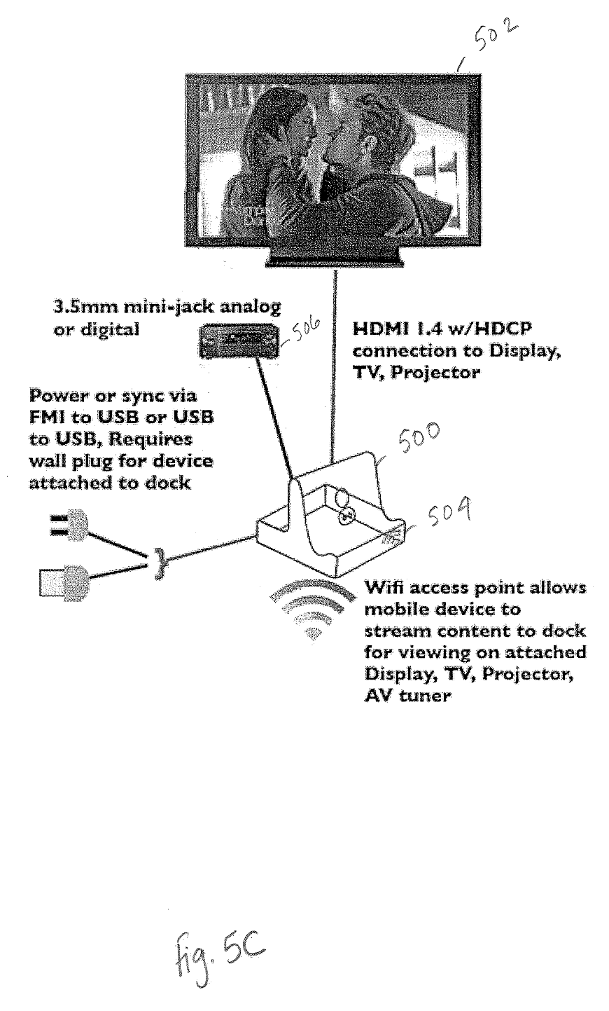

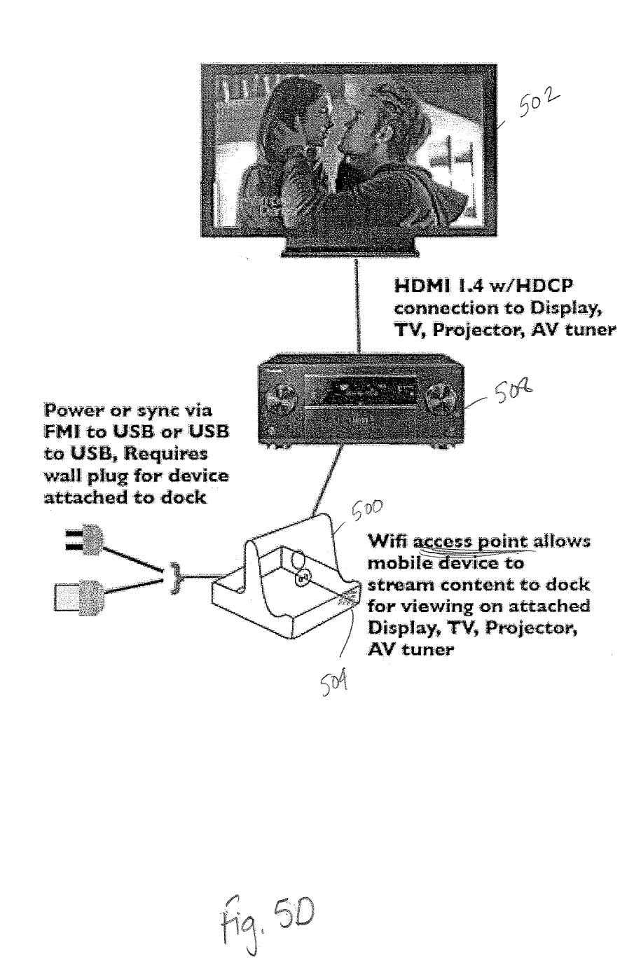

Referring now to FIGS. 5A-5D, therein illustrated are example devices in communication with a docking system in accordance with an aspect of the present invention. For example, FIG. 5A illustrates a television 502 in communication with docking system 500 via a HDMI port. Referring now to FIG. 5B, therein illustrated is an example Wifi access point 504 on the docking system 500. FIG. 5C illustrates a sound system 506 in communication with the docking system 500 via the 3.5 mm mini-jack port. In addition, FIG. 5D illustrates an AV tuner 508 in communication with the docking system 500 via the HDMI port.

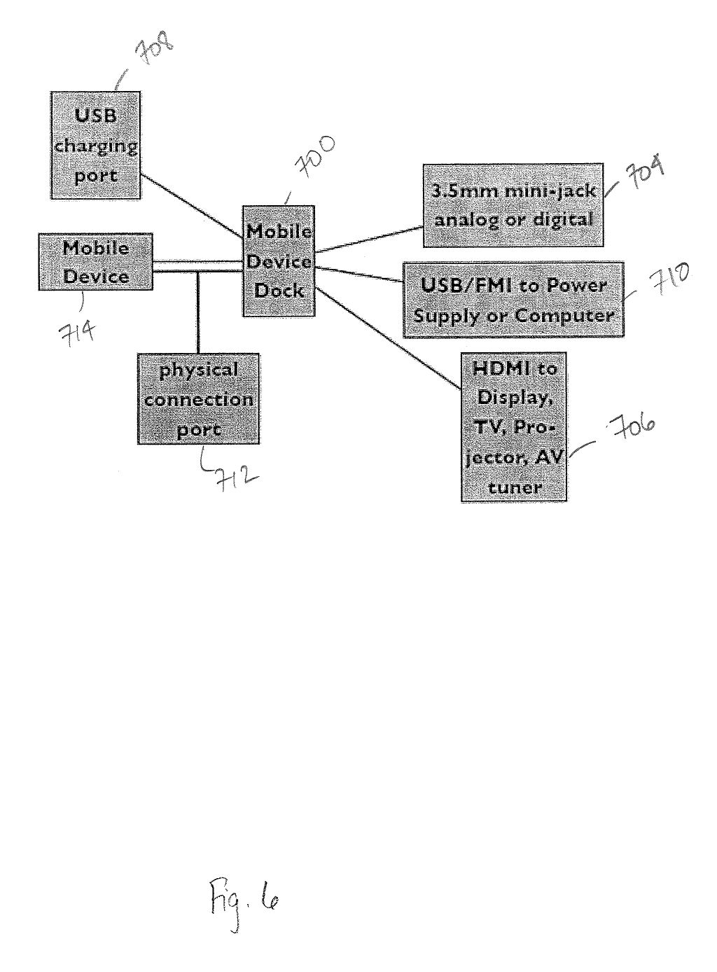

Referring now to FIG. 6, therein illustrated is an example overall description of a docking system 700 in accordance with an aspect of the present invention. For example, the docking device 700 may include a USB charging port 708, a mini-jack port 704 for analog or digital signals, a USB or FMI power supply 710, a HDMI tuner 706, and/or a physical connection port 712 to a mobile device 714.

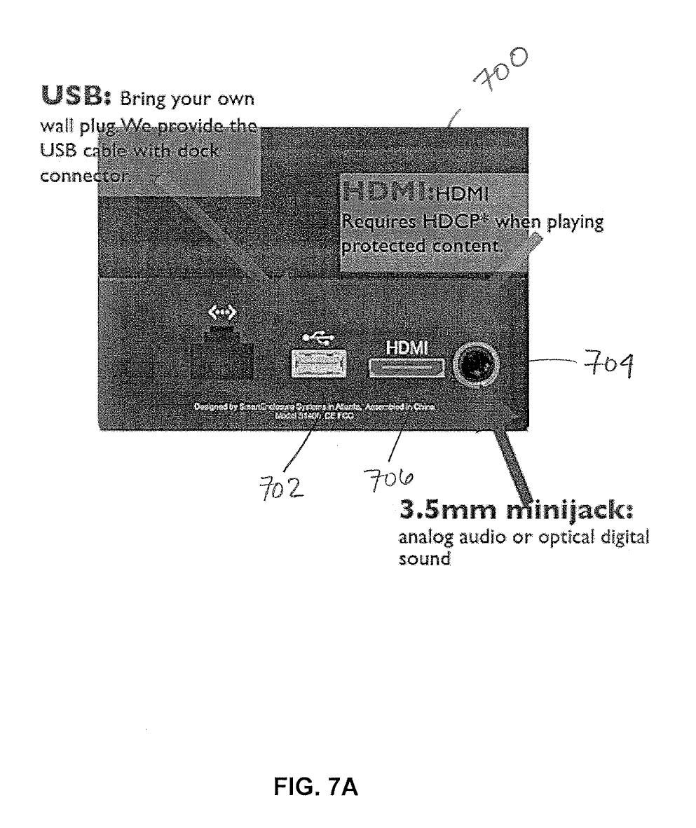

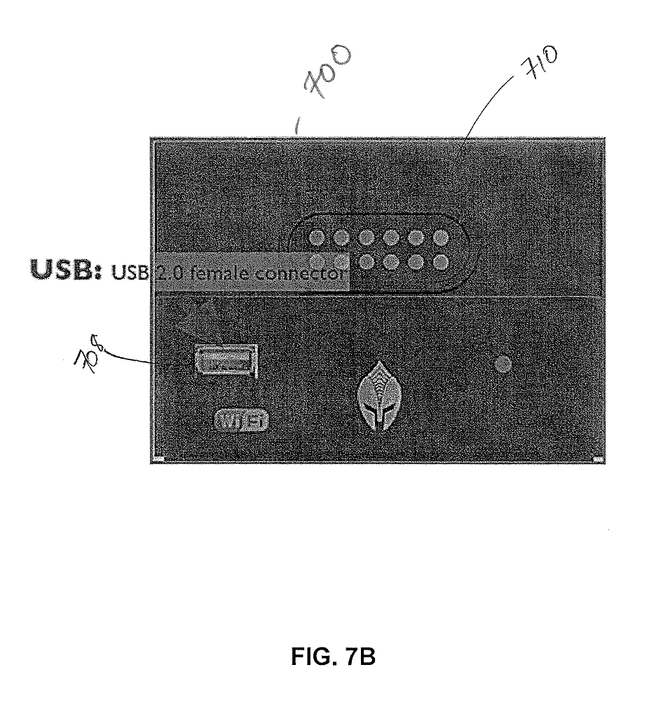

Referring now to FIG. 7A, therein illustrated is a rear view of the docking system shown in FIG. 6. For example, the docking system 700 may have a power port 702 configured to receive power from a wall outlet via a power cord. The docking system may also include a HDMI port 706 that may be used to connect to a display, a television, a projector and/or an AV receiver. In an aspect, the HDMI port 706 may integrate high-bandwidth digital content protection (HDCP) to prevent the interception of digital data midstream between the source and display, and thus, allow the playing of protected content via the HDMI port 706. In addition, the docking system may include an audio mini-jack port 704, such as a 3.5 mm mini-jack, to for analog or optical digital sound (e.g., Toslink).

Referring now to FIG. 7B, therein illustrated is a front view of the docking system 700 shown in FIG. 6. The docking system may include a USB port 708. The USB port 708 may allow charging of non-dockable mobile devices and/or data transfers to mobile devices. In addition, the docking system may include a FMI 710 to connect and/or dock a mobile device to the docking system. As discussed above, the FMI 710 may provide both a mechanical connection to the wireless device (e.g., join the wireless device to the docking system) and an electrical connection (e.g., provide a power supply and/or recharge a power source to the mobile device).

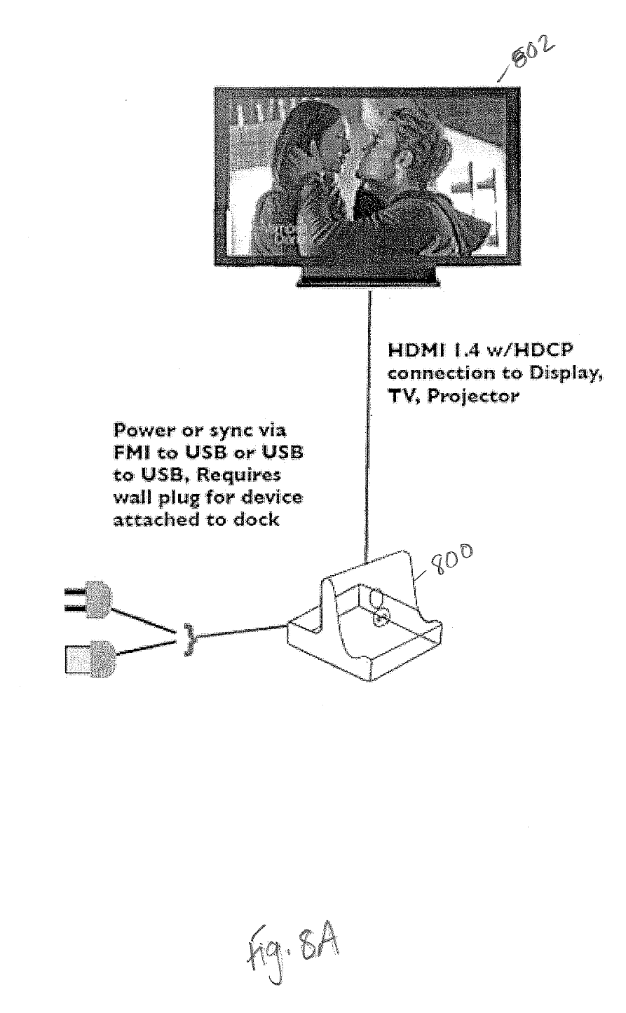

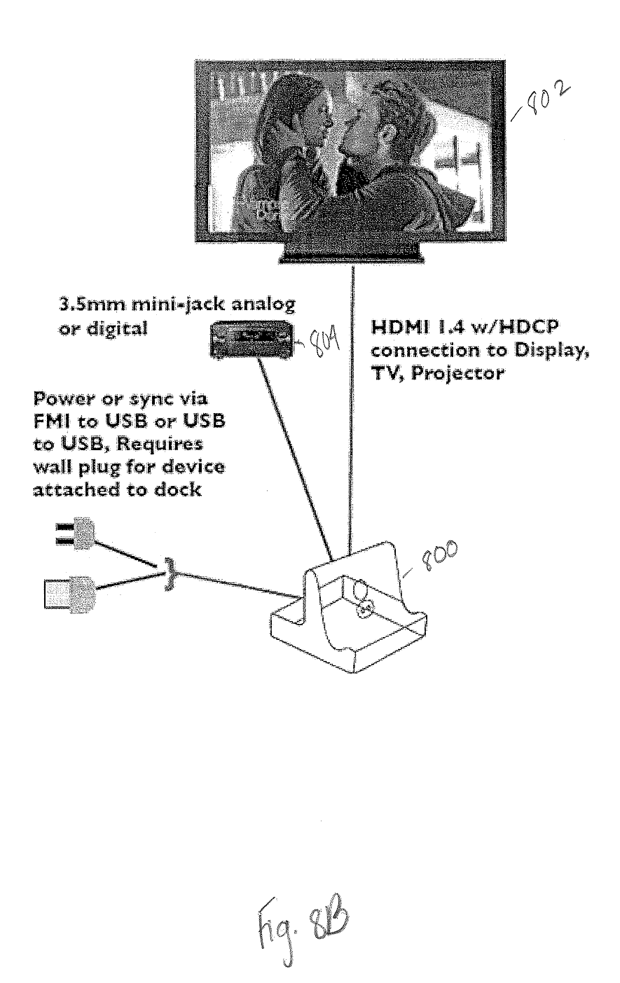

Referring now to FIGS. 8A-8B, therein illustrated are example devices in communication with the docking system in accordance with an aspect of the present invention. FIG. 8A illustrates a television 802 in communication with docking system 800 via a HDMI port, and FIG. 8B illustrates a sound system 804 in communication with the docking system 800 via the 3.5 mm mini-jack port.

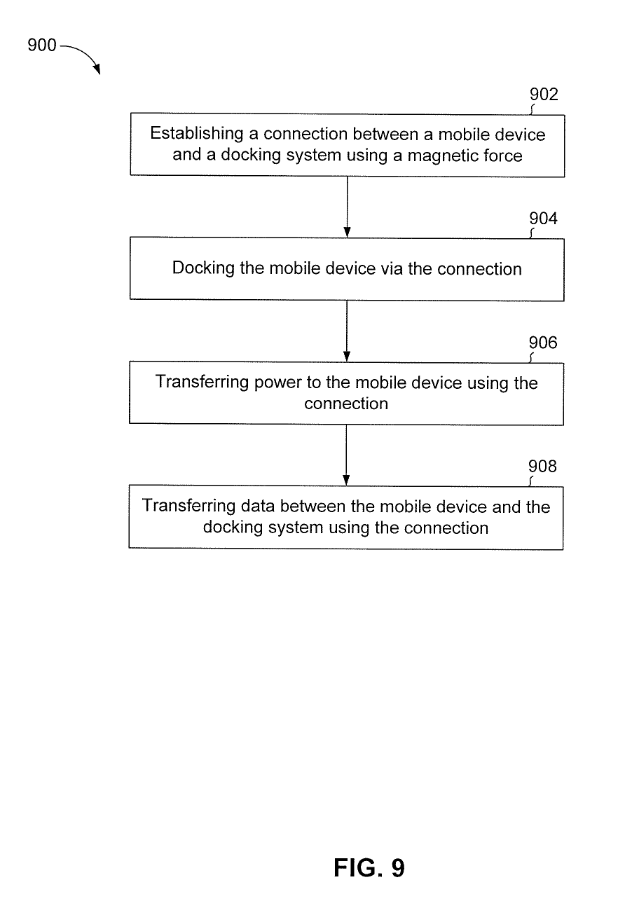

Referring now to FIG. 9, illustrated therein is an example method flow 900 for docking a portable device in accordance with an aspect of the present invention. The method may include establishing a connection between a mobile device and a docking system using a magnetic force 902. In an aspect, the connection established may be a mechanical connection and/or an electrical connection. For example, docking system 100 (FIG. 1) may include a FMI 102 (FIG. 1) with a plurality of magnets floating behind a plurality of contact points. In addition, mobile device 200 (FIG. 1) may contain a set of magnets and/or magnetic material that may generate a magnetic force with FMI 102 and establish a connection with docking system 100 using the magnetic force.

The method may include docking the portable device via the connection 904. In an aspect, a mechanical connection between the mobile device and the docking system may be capable of joining the mobile device to the docking system. For example, the magnetic force generated between the magnets in the mobile device 200 (FIG. 2) and the magnets in the FMI 102 (FIG. 2) may join and/or connect mobile device 200 to the docking system 100.

In addition, the method may also include transferring power to the mobile device using the connection 906. In an aspect, when the connection established with the magnetic force is an electrical connection, power may be transmitted to the mobile device from the docking system. For example, the electrical connection may provide a power supply and/or recharge a power source on the mobile device.

The method may also include transferring data between the mobile device and the docking system using the connection 908. In an aspect, when the connection established with the magnetic force is an electrical connection, a data connection may be established between the docking system and the mobile device. For example, a mobile device with an electrical connection with a docking system may be able to receive data from the docking system and/or one or more devices in communication with the docking system using the data connection. In addition, a mobile device with an electrical connection with a docking system may be able to transmit data to the docking system and/or one or more devices in communication with the docking system using the data connection.

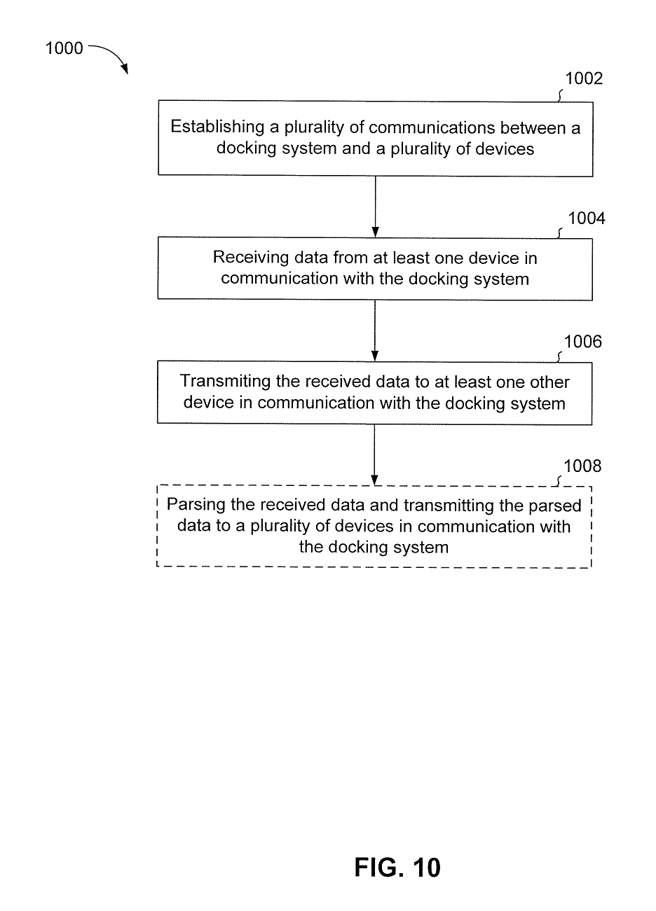

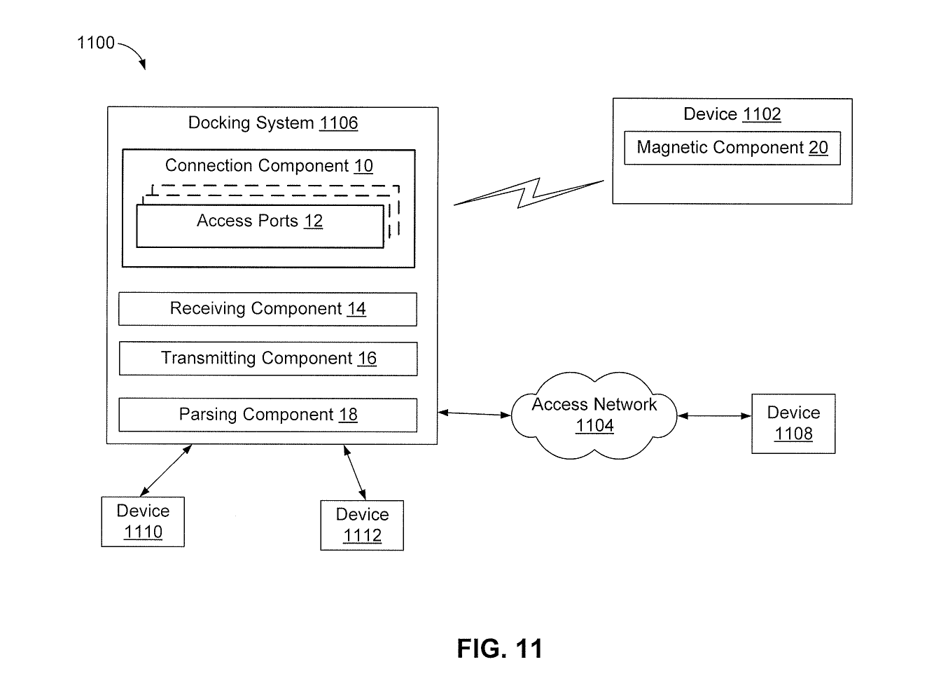

Referring now to FIG. 10, illustrated therein is an example method flow 1000 for providing a central hub for data communications among devices in communication with a docking system in accordance with an aspect of the present invention. The method may include establishing a plurality of communications between a docking system and a plurality of devices 1002. In an aspect, docking system 1106 (FIG. 11) may have a plurality of ports and/or access points 12 (FIG. 11) that may allow one or more devices 1102, 1108, 1110, 1112 (FIG. 11) to communicate with the docking system. For example, the docking system may have a Wifi access point that may allow a plurality of devices (e.g., 2, 3, 4 or more devices) to communicate with the docking system concurrently via the Wifi access point. In addition, the docking system may have a FMI which may allow a device to communicate with the docking system through the magnetic connection established between the FMI and magnets in the device. The docking system may also include a USB port that allows a device to communicate with the docking system through the USB port. In another example, the docking system may have a HDMI port that may allow a device, such as a television and/or a projector to communicate with the docking system. In addition, the docking system may have a mini-jack port that allows a device, such as a sound system to communicate with the docking system. As such, the docking system may have a variety of ports and/or access points that may allow a plurality of devices to communicate concurrently with the docking system.

The method may also include receiving data from at least one device in communication with the docking system 1004. In an aspect, a receiving component 14 (FIG. 11) on docking system 1106 may receive data from device 1108 in communication with docking system 1106. For example, device 1108 may be a computer in communication with docking system 1106 via a Wifi access point on docking system 106. Device 1108 may send data, such as, but not limited to, a movie, television show, and/or music to docking system 1106 via the Wifi access point. In another aspect, receiving component 14 may receive data from device 1102 in communication with docking system 1106. For example, device 1102 may be a mobile device in communication with docking system 1106 via a FMI attached to docking system 1106. Device 1102 may send docking system 1106 data, such as, but not limited, photographs, videos, text files, music, electronic books, and/or games, via the FMI connection.

The method may also include transmitting the received data to at least one other device in communication with the docking system 1006. For example, a transmitting component 16 (FIG. 11) on docking system 1106 may transmit the received data to one or more devices 1102, 1108, 1110, 1112 in communication with docking system 1106. For example, the received data may be photographs and transmitting component 16 may transmit the photographs to output device 1110 (e.g., a projector or printer) in communication with docking system 1106 so that device 1110 may display the photographs. In another example, the received data may be music and transmitting component 16 may transmit the music to device 1112 (e.g., an audio system) in communication with docking system 1106 so that device 1112 may play the music. As such, the docking system may facilitate data communication among a plurality of devices in communication with the docking system.

The method may optionally include parsing the received data and transmitting the parsed data to a plurality of devices in communication with the docking system 1008. In an aspect, docking system 1106 may have a parsing component 18 (FIG. 11) that may parse the received data and transmitting component 16 may transmit the parsed data to a plurality of devices in communication with the docking system 1106. For example, the received data may be a movie and parsing component 18 may parse the received data into a video file and an audio file. Transmitting component 16 may transmit the video file to device 1110 (e.g., a projector) in communication with docking system 1106 to play the video file. In addition, transmitting component 16 may transmit the audio file to device 1112 (e.g., a sound system) in communication with docking system 1106 to play the audio file. Thus, the docking system may split the received data into a plurality of data files and transmit separate data files to different devices in communication with the docking system. As such, the docking system may act as a central hub for data communications among a plurality of devices in communication with the docking system.

Referring now to FIG. 11, illustrated therein is an example system 1100 in accordance with an aspect of the present invention. System 1100 may include a docking system 1106 in communication with one or more devices 1102, 1108, 1110, and 1112. Docking system 1106 may include a connection component 10 operable to establish connections and/or communications with one or more of devices 1102, 1108, 1110, and 1112. In an aspect, connection component 10 may interface with one or more access ports and/or points 1112 on docking system 1106 to establish the connections with the one or more devices 1102, 1108, 1110, and 1112. Access ports and/or points 1112 may include, but are not limited to, a FMI, a power port, a HDMI port, an audio mini-jack port, an USB port, and a Wifi access point.

In an aspect, device 1102 may include a magnetic component 20 operable to connect device 1102 to docking system 1106. For example, the magnetic force generated between the magnets and/or magnetic material in magnetic component 20 and a FMI access port 1112 may connect device 1102 to docking system 1106. In another aspect, device 1108 may communicate with docking system via access network 1104. For example, device 1108 may access a Wifi access point 1112 on docking system via access network 1104. In an aspect, devices 1102, 1108, 1110, and 1112, or any combination thereof, may be concurrently in communication with docking system 1106.

Docking system 1106 may also include a receiving component 14 operable to receive data from one or more of devices 1102, 1108, 1110, and 1112 in communication with docking system 1106. Data may include, but is not limited to, movies, television shows, photographs, videos, games, electronic books, text, and music, among other forms of content capable of being transmitted from a device. For example, receiving component 14 may interface with connection component 10 to receive the data from the one or more devices in communication with docking system 1106.

Docking system 1106 may also include a transmitting component 16 operable to transmit the received data to one or more devices 1102, 1108, 1110, and 1112. For example, transmitting component 16 may interface with connection component 10 to transmit the data to devices 1102, 1108, 1110, and 1112 via the one or more access ports 12. Docking system 1106 may also include a parsing component 18 operable to parse the received data. For example, if the received data is a movie, parsing component 18 may parse the received data into video data and audio data. Parsing component may interface with transmitting component 16 to transmit the video data to a device capable of presenting the video data and transmit the audio data to a device capable of playing the audio data.

Aspects of the present invention may use various wireless protocols. The wireless protocols may include, but are not limited to: Wi-Fi certified; interoperable with Wi-Fi Certified 802.11a, 802.11b, 802.11g, and 802.11n-enabled Mac computers, Windows-based PCs, and other Wi-Fi devices; and NAT, DHCP, PPPoE, VPN Passthrough (IPSec, PPTP, and L2TP), DNS Proxy, SNMP, IPv6 (6to4 and manual tunnels).

In addition, aspects of the present invention may use various interfaces. Interfaces may include, but are not limited to, 802.11n wireless, configurable output power, web based setup utility, One 10/100BASE-T Ethernet port for connecting a DSL modem, cable modem, or Ethernet network, 3.5 mm audio minijack for analog or optical digital sound, HDMI version 1.4, and USB 2.0.

Aspects of the present invention may also use electrical and environmental requirements, such as, but not limited to, USB 2.0. Moreover, aspects of the present invention may use frequency bands, such as, but not limited to, 2.4 GHz or 5 GHz.

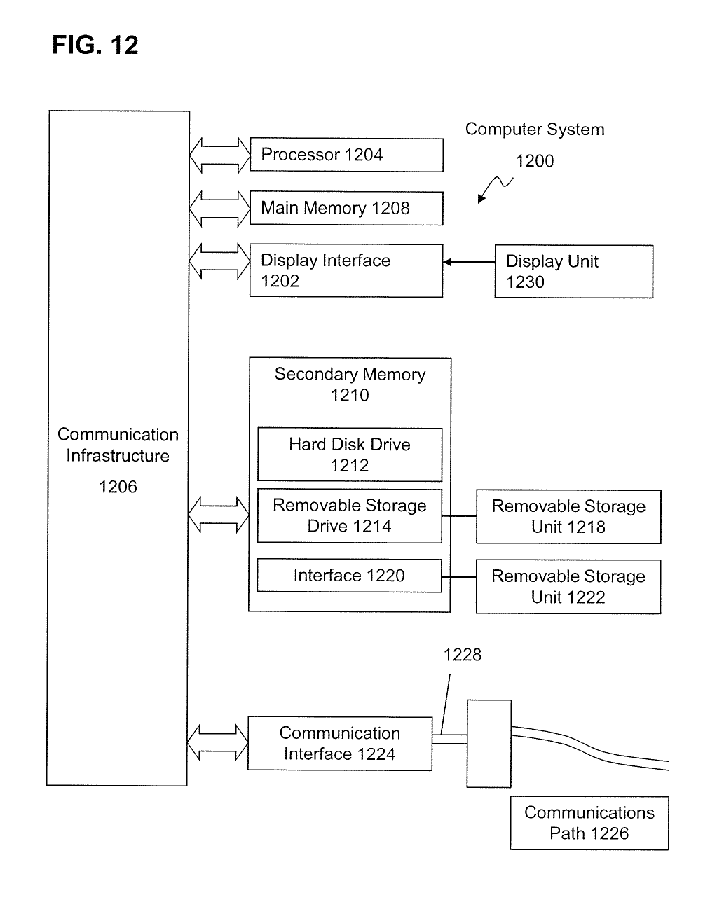

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 1200 is shown in FIG. 12.

Computer system 1200 includes one or more processors, such as processor 1204. The processor 1204 is connected to a communication infrastructure 1206 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 1200 can include a display interface 1202 that forwards graphics, text, and other data from the communication infrastructure 1206 (or from a frame buffer not shown) for display on a display unit 1230. Computer system 1200 also includes a main memory 1208, preferably random access memory (RAM), and may also include a secondary memory 1210. The secondary memory 1210 may include, for example, a hard disk drive 1212 and/or a removable storage drive 1214, representing a floppy disk drive, a magnetic tape drive, an optical disk drive, etc. The removable storage drive 1214 reads from and/or writes to a removable storage unit 1218 in a well-known manner. Removable storage unit 1218, represents a floppy disk, magnetic tape, optical disk, etc., which is read by and written to removable storage drive 1214. As will be appreciated, the removable storage unit 1218 includes a computer usable storage medium having stored therein computer software and/or data.

Alternative aspects of the present invention may include secondary memory 1210 and may include other similar devices for allowing computer programs or other instructions to be loaded into computer system 1200. Such devices may include, for example, a removable storage unit 1222 and an interface 1220. Examples of such may include a program cartridge and cartridge interface (such as that found in video game devices), a removable memory chip (such as an erasable programmable read only memory (EPROM), or programmable read only memory (PROM)) and associated socket, and other removable storage units 1222 and interfaces 1220, which allow software and data to be transferred from the removable storage unit 1222 to computer system 1200.

Computer system 1200 may also include a communications interface 1224. Communications interface 1224 allows software and data to be transferred between computer system 1200 and external devices. Examples of communications interface 1224 may include a modem, a network interface (such as an Ethernet card), a communications port, a Personal Computer Memory Card International Association (PCMCIA) slot and card, etc. Software and data transferred via communications interface 1224 are in the form of signals 1228, which may be electronic, electromagnetic, optical or other signals capable of being received by communications interface 1224. These signals 1228 are provided to communications interface 1224 via a communications path (e.g., channel) 1226. This path 1226 carries signals 1228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1280, a hard disk installed in hard disk drive 1270, and signals 1228. These computer program products provide software to the computer system 1200. The invention is directed to such computer program products.

Computer programs (also referred to as computer control logic) are stored in main memory 1208 and/or secondary memory 1210. Computer programs may also be received via communications interface 1224. Such computer programs, when executed, enable the computer system 1200 to perform the features in accordance with aspects of the present invention, as discussed herein. In particular, the computer programs, when executed, enable the processor 1210 to perform the features in accordance with aspects of the present invention. Accordingly, such computer programs represent controllers of the computer system 1200.

In an aspect of the present invention where the invention is implemented using software, the software may be stored in a computer program product and loaded into computer system 1200 using removable storage drive 1214, hard drive 1212, or communications interface 1220. The control logic (software), when executed by the processor 1204, causes the processor 1204 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

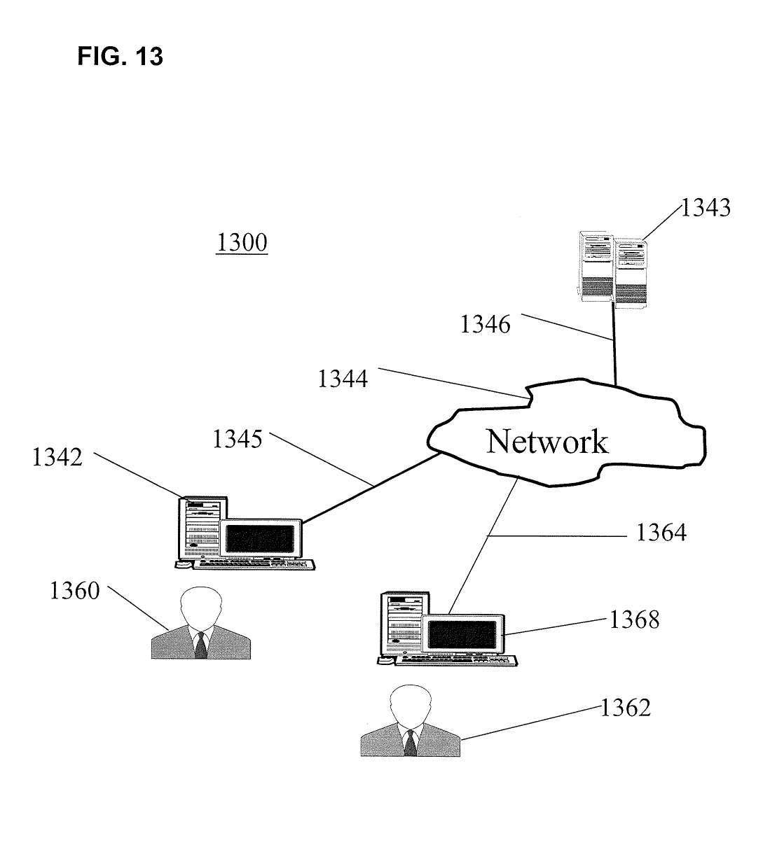

FIG. 13 shows a communication system 1300 usable in accordance with aspects of the present invention. The communication system 1300 includes one or more accessors 1360, 1362 (also referred to interchangeably herein as one or more “users”) and one or more terminals 1342, 1366. In one aspect of the present invention, data for use is, for example, input and/or accessed by accessors 1360, 1364 via terminals 1342, 1366, such as personal computers (PCs), minicomputers, mainframe computers, microcomputers, telephonic devices, or wireless devices, such as personal digital assistants (“PDAs”) or a hand-held wireless devices coupled to a server 1343, such as a PC, minicomputer, mainframe computer, microcomputer, or other device having a processor and a repository for data and/or connection to a repository for data, via, for example, a network 1344, such as the Internet or an intranet, and couplings 1345, 1346, 1364. The couplings 1345, 1346, 1364 include, for example, wired, wireless, or fiberoptic links. In another aspect of the present invention, the method and system of the present invention operate in a stand-alone environment, such as on a single terminal.

While the present invention has been described in connection with aspects of the present invention, it will be understood by those skilled in the art that variations and modifications of the aspects of the present invention described above may be made without departing from the scope of the invention. Other aspects will be apparent to those skilled in the art from a consideration of the specification or from a practice of the invention disclosed herein.

1. A method of docking a portable device, comprising:
establishing a connection between the portable device and a docking system using a magnetic force generated between a flexible magnetic interface attached to the docking system and magnetic material attached to the mobile device;
docking the portable device via the connection;
transferring power to the portable device using the connection; and
transferring data between the portable device and the docking system using the connection.

2. The method of claim 1, wherein the magnetic force creates a mechanical connection between the docking system and the portable device.

3. The method of claim 1, wherein the magnetic force creates an electrical connection between the docking system and the portable device.

4. A docking system, comprising:
a flexible magnetic interface operable to establish a connection between a portable device and the docking system and attach the portable device to the docking system using the connection, wherein the connection is established by using a magnetic force generated between the flexible magnetic interface and magnetic material attached to the portable device; and
a transmitting component operable to transfer power and data to the portable device using the connection.

5. The docking system of claim 4, wherein the magnetic force creates a mechanical connection between the docking system and the portable device.

6. The docking system of claim 4, wherein the magnetic force creates an electrical connection between the docking system and the portable device.

7. A method for providing a central hub for data communications among devices in communication with a docking system, comprising:
establishing a plurality of communications between a docking system and a plurality of devices;
receiving data from at least one device in communication with the docking system; and
transmitting the received data to at least one other device in communication with the docking system.

8. The method of claim 7, further comprising:
parsing the received data; and
transmitting the parsed data to the plurality of devices in communication with the docking system.

9. The method of claim 7, wherein the communications are established via a plurality of ports on the docking system.

10. The method of claim 9, wherein the plurality of ports comprise one or more of a flexible magnetic interface, an HDMI port, a mini-jack port, a universal serial bus port, and a Wifi data access point.

11. A docking system for providing a central hub for data communications among devices in communication with the docking system, comprising:
a connection component operable to establish a plurality of communications between the docking system and a plurality of devices;
a receiving component operable to receive data from at least one device in communication with the docking system; and
a transmitting component operable to transmit the received data to at least one other device in communication with the docking system.

12. The docking system of claim 11, further comprising:
a parsing component operable to parse the received data; and
the transmitting component being further operable to transmit the parsed data to the plurality of devices in communication with the docking system.

13. The docking system of claim 11, further comprising:
a plurality of ports operable to establish the communications.

14. The docking system of claim 13, wherein the plurality of ports comprise one or more of a flexible magnetic interface, an HDMI port, a mini-jack port, a universal serial bus port, and a Wifi data access point.

15. A computer program product comprising a computer usable medium having control logic stored therein for causing a computer to provide a central hub for data communications, the control logic comprising:
at least one instruction for causing a computer to establish a plurality of communications between a docking system and a plurality of devices;
at least one instruction for causing the computer to receive data from at least one device in communication with the docking system; and
at least one instruction for causing the computer to transmit the received data to at least one other device in communication with the docking system.

16. A docking system for providing a central hub for data communications, the docking system comprising:
a processor;
a user interface functioning via the processor; and
a repository accessibly by the processor;
wherein a plurality of communications are established between a docking system and a plurality of devices;
wherein data is received from at least one device in communication with the docking system; and
wherein the received data is transmitted to at least one other device in communication with the docking system.

17. A docking system, comprising:
a flexible magnetic interface configured to connect a portable device to the docking system;
an HDMI port;
a mini-jack port; and
a universal serial bus port.

18. The docking system of claim 1, further comprising:
a Wifi data access point.
